(19) United States
(12) Patent Application Publication
(10) Pub. No.: US 2011/0204615 A1
(43) Pub. Date: Aug. 25, 2011

(54) Mickie's book clip

(75) Inventor: Michele R. Roberts, Portland, OR (US)

(73) Assignee: Michele Rene' Roberts, Portland, OR (US)

(21) Appl. No.: 12/660,126

(22) Filed: Feb. 22, 2010

(51) Int. Cl. B42D 9/00

(52) U.S. Cl. 281/42

(57) ABSTRACT

A dip for holding open a book while it is being read, with two integrated clamp and handle pieces to respectively hold the front and back covers of the open book, independently hinged to a single integrated clamp and handle piece to hold the open pages of the book, where the damping force is provided by a helical spring on each hinge, and a rubber strip is affixed to each of the three damping surfaces.

### BACKGROUND OF THE INVENTION

The need for an aid to holding open a book during long reading sessions is well established. Many such aids have been devised over time which reduce hand fatigue, and allow the reader to continue enjoying a story well into a significant state of drowsiness. However, all prior solutions suffer from complexity and cumbersomeness, forcing the reader to focus on the mechanics of the device rather than the flow of the story being read.

### BRIEF SUMMARY OF THE INVENTION

Mickie's Book Clip is a device for holding open a book during long reading sessions. Its novel design is both effective and simple, providing a minimum of distraction to the reader.

### DETAILED DESCRIPTION OF THE INVENTION

A book dip, consisting of three integrated clamp and handle pieces (hereafter referred to as “clandles”). The dandles are curved in such a way to form a comfortable gripping angle at the top, and, moving down, to curve away from the top edge of the book, and then curve back toward the book at the point at which it needs to clamp. The front clandle is a single piece, to be placed against the book pages being held open. The back clandles are sized to be slightly less than half the length of the front clandle, such that when mounted side-by-side they are the same length as the front clandle given a slight gap between them. The back dandles are independently hinged to the front clandle, with the hinges positioned such as to give balanced support when the whole is gripped by an average hand in a natural manner. The two back dandles are thereby free to independently damp the corresponding halves of the book, with the gap straddling the spine, thus accommodating the different thicknesses of the book halves which would normally occur during its reading. The two hinges also support one helical spring each, arranged to push the back and front dandles together at the clamp ends, thus providing the clamping force. Each of the three dandles has a rubber strip affixed at the damping end, to reduce the chances of slipping against the book.

### BRIEF DESCRIPTION OF THE SEVERAL VIEWS OF THE DRAWING

FIG. 1 is a top view, showing the relationship between one front and two back damp pieces, as well as the orientation and placement of the hinges and springs.

FIG. 2 is an end view, showing the clip opened to its maximum useful limit.

FIG. 3 is a side view, darifying the relationship of the front and back clamp pieces.

FIG. 4 shows an end-view of the clip in the nearly-closed position where the overall vertical height can be easily visualized, as well as darifying the relationship of the various components.

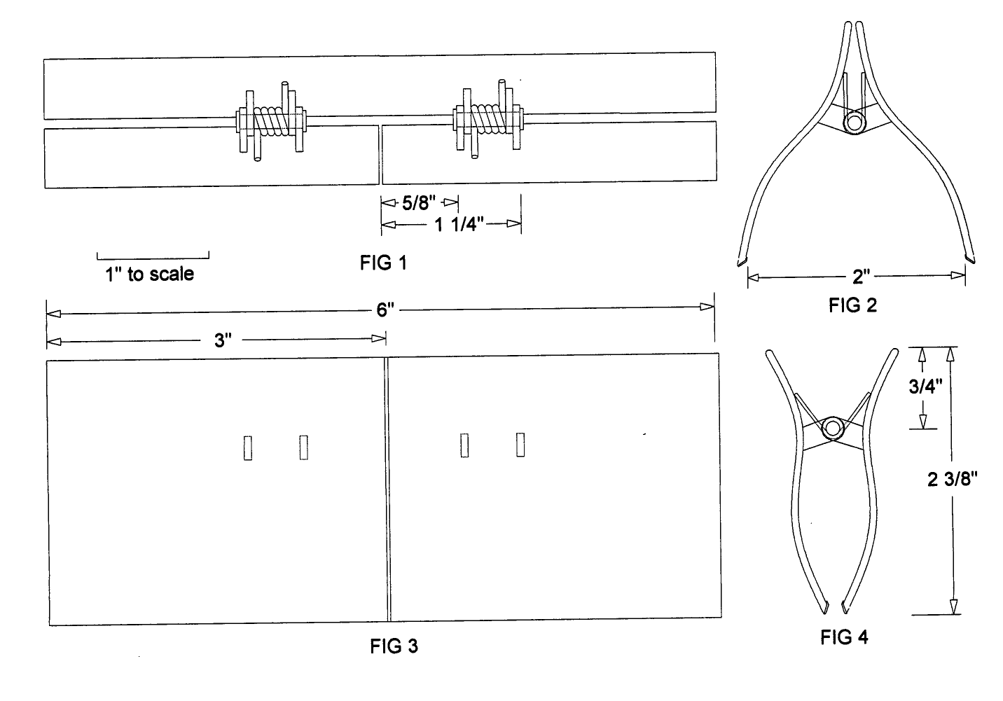

1. A clamp for holding a book open, where the side used on the open pages (the front) is a single, straight jaw that crosses the binding, holding the pages flat with respect to the reader, and the side used on the book cover (the back) is split into two jaws, independently hinged to the front jaw, straddling the binding such that a significant difference in thickness between the two sides can be accommodated.

2. A clamp as described in claim 1 where the jaws curve out and away from the book at the hinges, then curve back in toward the book at the contact surface, so as to avoid contacting the book at an unintended location.

3. A clamp as described in claim 1 where the contact surface of the jaws has affixed a strip of rubber, so that the clamp is less likely to slip against the book.

4. A clamp as described in claim 1 where the jaws extend beyond and away from the hinges to form a comfortable gripping handle, which can be squeezed to open the clamp or released to close it.

5. A clamp as described in claim 4 where the hinges are placed such that the squeezing needed to open both back jaws can be comfortable opened simultaneously with a single average-sized hand used in a natural manner.

6. A clamp as described in claim 4 where the hinges incorporate a helical spring, arranged so as to force the damp dosed when the handles are released.
